(19) United States
(12) Patent Application Publication
(10) Pub. No.: US 2021/0347460 A1
(43) Pub. Date: Nov. 11, 2021

(54) AIRSHIP AND METHOD OF USE

(71) Applicant: Aloft Research Corporation, Sunnyvale, CA (US)

(72) Inventors: David Watters, Sunnyvale, CA (US); Lauren Wye, Sunnyvale, CA (US); Patrick Rennich, Sunnyvale, CA (US); Matthew Watters, Sunnyvale, CA (US)

(21) Appl. No.: 16/868,303

(22) Filed: May 6, 2020

(51) Int. Cl. B64B 1/44; B64B 1/62; B64C 39/02; G05D 1/04; G05D 1/10

(52) U.S. Cl. CPC B64B 1/44; B64B 1/62; B64C 39/024; G05D 1/046; B64C 2201/12; B64C 2201/022; B64C 2201/101; B64C 2201/042; B64C 2201/16; G05D 1/104

(57) ABSTRACT

An airship comprising an envelope having a shape, a volume, and a frontal area. A lifting gas within the envelope. A propulsion system. A volume change mechanism arranged to change the shape of the envelope, wherein the change in shape of the envelope changes the volume of the envelope, the change in volume of the envelope causes a change in the buoyancy of the airship, and the change in shape of the envelope causes the frontal area of the envelope to change proportionally to the change in volume of the envelope.

The present application relates to an airship and a method of use of the airship.

### BACKGROUND

There are a number of situations in which it is desirable to be able to have sensing or communications systems over a location or area for an extended period of time, in order to conduct surveillance or monitoring of a location, or to provide communications services. It is known to provide such systems over a location by mounting them on a satellite, aircraft or balloon.

However, there are problems with such known approaches. In general, to conduct continuous surveillance of particular location by satellite it is necessary to deploy a constellation of numerous satellites, which is very expensive. Some sensing and communications services can be provided by geostationary satellites, but the resulting communications latency and sensing modes may not meet the needs of some users. Aircraft have limited endurance so that long-term surveillance requires multiple aircraft, which is expensive. Further, aircraft may be vulnerable to detection and attack. Balloons are individually inexpensive, but because they tend to blow away from any particular location it can be difficult to maintain continuous coverage, and very large numbers of balloons may be required. This can be expensive, and can lead to complaints when the balloons come back to earth as this is often at an uncontrolled location.

Solar powered UAVs are known, but these are generally fragile and expensive.

The embodiments described below are not limited to implementations which solve any or all of the disadvantages of the known approach described above.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a first aspect, the present disclosure provides an airship comprising: an envelope having a shape, a volume, and a frontal area; a lifting gas within the envelope; a propulsion system; and a volume change mechanism arranged to change the shape of the envelope; wherein the change in shape of the envelope changes the volume of the envelope; wherein the change in volume of the envelope causes a change in the buoyancy of the airship; and wherein the change in shape of the envelope causes the frontal area of the envelope to change proportionally to the change in volume of the envelope.

Optionally, the airship has a longitudinal axis and the frontal area of the envelope is the cross-sectional area of the envelope perpendicular to the longitudinal axis.

Optionally, the propulsion system has a thrust axis and the frontal area of the envelope is the cross-sectional area of the envelope perpendicular to the thrust direction.

Optionally, wherein the volume change mechanism is arranged so that a surface area of the envelope remains constant when the shape of the envelope is changed.

Optionally, the envelope is sealed.

Optionally, the change in volume of the envelope causes a change in the pressure of the lifting gas.

Optionally, the volume change mechanism is arranged to urge opposing surfaces of the envelope towards one another to decrease the volume of the envelope.

Optionally, the volume change mechanism comprises at least one cable arranged to pull opposing surfaces of the envelope towards one another to decrease the volume of the envelope.

Optionally, the volume change mechanism is arranged to allow opposing surfaces of the envelope to move away from one another urged by the pressure of the lifting gas to increase the volume of the envelope.

Optionally, the airship has a longitudinal axis or a thrust axis; and the volume change mechanism is arranged to urge opposing surfaces of the envelope towards one another at points which lie on a plane perpendicular to the axis to decrease the volume of the envelope.

Optionally, the volume change mechanism is arranged to urge opposing surfaces of the envelope towards one another at points which lie on multiple planes perpendicular to the axis to decrease the volume of the envelope.

Optionally, the shape of the envelope comprises two tapered sections each having a base, the two tapered sections being arranged extending in opposite directions with their respective bases facing one another.

Optionally, the two tapered sections are arranged with their bases in contact.

Optionally, wherein the tapered sections are arranged with their bases separated by one or more sections having a constant cross-section.

Optionally, the two tapered sections are pyramids.

Optionally, the two tapered sections have rectangular or square bases.

Optionally, the airship further comprises a support member extending along the axis.

Optionally, the support member is at least one of: a spar; a rod; or a cable.

Optionally, the envelope is transparent, in whole or in part.

Optionally, the propulsion system comprises one or more fans or propellers.

Optionally, the fans or propellers are vectorable.

Optionally, the fans or propellers are ducted fans.

Optionally, the airship further comprises at least one solar collector photo-voltaic (PV) panel arranged to provide electrical power to the airship.

Optionally, the airship further comprises at least one battery arranged to store electrical power.

Optionally, the airship further comprises a fuel store and engine arranged to generate power.

Optionally, the airship further comprises a satellite communication system.

Optionally, the airship further comprises at least two satellite positioning systems.

Optionally, the airship further comprises a payload, wherein the payload comprises one of more of: a sensor system; a radar system; a lidar system; a camera; an electro optical system; an infra-red imager; and/or a communications relay.

Optionally, the airship further comprises a frame supporting the envelope.

Optionally, the frame is a rigid frame or a semi-rigid frame.

In a second aspect, the present disclosure provides a method of operating an airship, the airship comprising: an envelope having a shape, a volume, and a frontal area; a lifting gas within the envelope; a propulsion system; and a volume change mechanism; the method comprising: operating the volume change mechanism to change a shape and a volume of the envelope; wherein the change in volume of the envelope causes a change in the buoyancy of the airship; and wherein the change in the buoyancy of the airship causes the airship to change altitude; wherein the change in shape of the envelope causes the frontal area of the envelope to change proportionally to the change in volume of the envelope.

Optionally, the airship has a longitudinal axis and the frontal area of the envelope is the cross-sectional area of the envelope perpendicular to the longitudinal axis.

Optionally, the propulsion system has a thrust axis and the frontal area of the envelope is the cross-sectional area of the envelope perpendicular to the thrust direction.

Optionally, a surface area of the envelope remains constant when the shape and volume of the envelope are changed.

Optionally, the change in volume of the envelope causes a change in the pressure of the lifting gas.

Optionally, further comprising obtaining information regarding wind conditions at different altitudes; identifying a wind condition at an altitude which is favorable for the airship to travel to a desired location; and operating the volume change mechanism to change the buoyancy of the airships and cause the airship to change altitude to the altitude of the identified wind condition.

Optionally, further comprising using the propulsion system to propel the airship

Optionally, the airship is station keeping at the desired location; and wherein the identifying a wind condition comprises identifying an altitude having a wind velocity lower than a maximum airspeed which the propulsion system can provide to the airship.

Optionally, the desired location is a predetermined area.

Optionally, the airship operates autonomously.

In a third aspect, the present disclosure provides a method of operating a plurality of airships to maintain at least one of the airships at a predetermined location, each airship comprising: an envelope having a shape, a volume, and a frontal area; a lifting gas within the envelope; a propulsion system; and a volume change mechanism: the method comprising: obtaining information regarding wind conditions at different altitudes; identifying a wind condition at an altitude which is favorable for at least one of the plurality of airships to travel to, or station keep at, the desired location; and for the at least one of the plurality of airships: operating the volume change mechanism of the airship to change a shape and a volume of the envelope; wherein the change in volume of the envelope causes a change in the buoyancy of the airship; and wherein the change in the buoyancy of the airship causes the airship to change altitude; wherein the change in shape of the envelope causes the frontal area of the envelope to change proportionally to the change in volume of the envelope; and operating the propulsion mechanism of the airship to travel towards, or keep station at, the predetermined location.

Optionally, in response to wind conditions at different altitudes being such that it is not possible to maintain a single airship of the plurality of airships at the predetermined location, the method further comprises, for at least a further one of the plurality of airships: operating the volume change mechanism of the airship to change a shape and a volume of the envelope; wherein the change in volume of the envelope causes a change in the buoyancy of the airship; and wherein the change in the buoyancy of the airship causes the airship to change altitude; wherein the change in shape of the envelope causes the frontal area of the envelope to change proportionally to the change in volume of the envelope; and operating the propulsion mechanism of the airship to travel towards, or keep station at, the predetermined location; whereby the at least one of the plurality of airships and the at least a further one of the plurality of airships are successively at the predetermined location.

Optionally, the plurality of airships operate using a sprint and drift procedure.

Optionally, the predetermined location is a predetermined area.

Optionally, the plurality of airships maintain a predetermined formation.

Optionally, the plurality of airships comprises a master airship, and the other airships of the plurality of airships maintain formation by following the movement of the master airship.

Optionally, the plurality of airships each comprise respective sensor systems which cooperate to carry out surveillance of the predetermined location.

Optionally, the respective sensor systems cooperate to form a synthetic aperture radar image.

Optionally, the plurality of airships each comprise respective communication systems which cooperate to provide communications services, wherein the respective communication systems cooperate to form a beamforming array.

The preferred features may be combined as appropriate, as would be apparent to a skilled person, and may be combined with any of the aspects of the invention.

### BRIEF DESCRIPTION OF THE DRAWINGS

Embodiments of the invention will be described, by way of example, with reference to the following drawings, in which:

FIG. 1 is a schematic diagram showing a side view of an airship according to a first embodiment;

FIG. 2 is a schematic diagram showing a plan view of the airship of FIG. 1;

FIG. 3 is a schematic diagram showing an end plan view of the airship of FIG. 1;

FIG. 4 is a schematic view of components of the airship of FIG. 1;

FIG. 5a shows a shape of an envelope of the airship of FIG. 1 when the volume of the envelope is a maximum;

FIG. 5b shows a shape of an envelope of the airship of FIG. 1 when the volume of the envelope is reduced;

FIG. 6a shows a cross-section through the envelope of the airship of FIG. 1 when the volume of the envelope is a maximum;

FIG. 6b shows a cross-section through the envelope of the airship of FIG. 1 when the volume of the envelope is reduced;

FIG. 7 is an explanatory diagram of a possible mission profile of the airship of FIG. 1;

FIGS. 8A to 8D show graphs of probability of successful station keeping by airships at respective different locations;

FIG. 9 is an explanatory diagram of a formation of two airships operating in a sprint and drift profile;

FIG. 10 is an explanatory diagram of areas of coverage of a formation of airships;

FIG. 11 is a side view of a frame of the airship of FIG. 1;

FIG. 12 is a plan view of the frame of FIG. 11;

FIG. 13 is an end view of the frame of FIG. 11;

FIG. 14 shows a side view of an airship according to a second embodiment;

FIG. 15a shows a shape of an envelope of the airship of FIG. 14 when the volume of the envelope is a maximum;

FIG. 15b shows a shape of an envelope of the airship of FIG. 14 when the volume of the envelope is reduced;

FIG. 16 shows a side view of an airship according to a third embodiment;

FIG. 17a shows a shape of an envelope of an airship of a fourth embodiment when the volume of the envelope is a maximum; and

FIG. 17b shows a shape of an envelope of the airship of FIG. 17a when the volume of the envelope is reduced.

Common reference numerals are used throughout the figures to indicate similar features.

### DETAILED DESCRIPTION

Embodiments of the present invention are described below by way of example only. These examples represent the best ways of putting the invention into practice that are currently known to the Applicant although they are not the only ways in which this could be achieved. The description sets forth the functions of the example and the sequence of steps for constructing and operating the example. However, the same or equivalent functions and sequences may be accomplished by different examples.

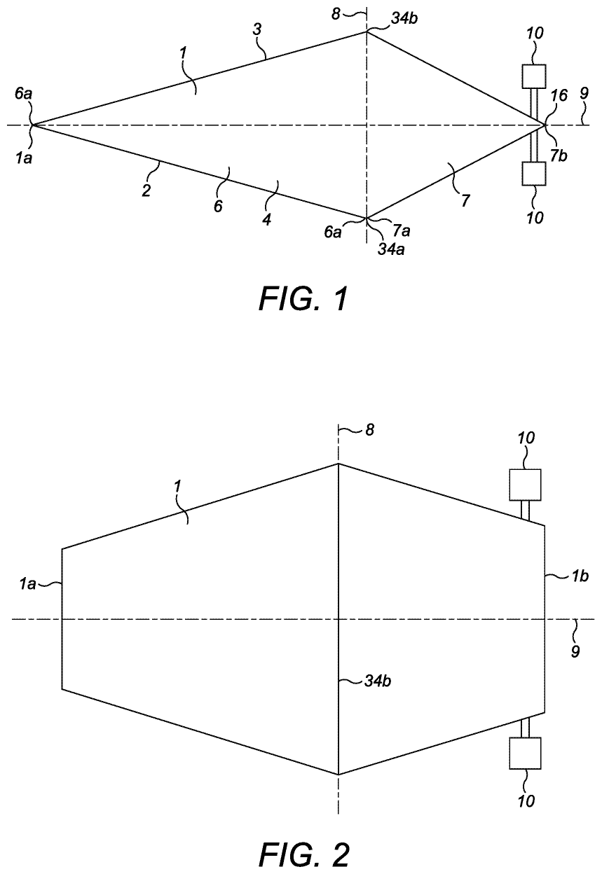

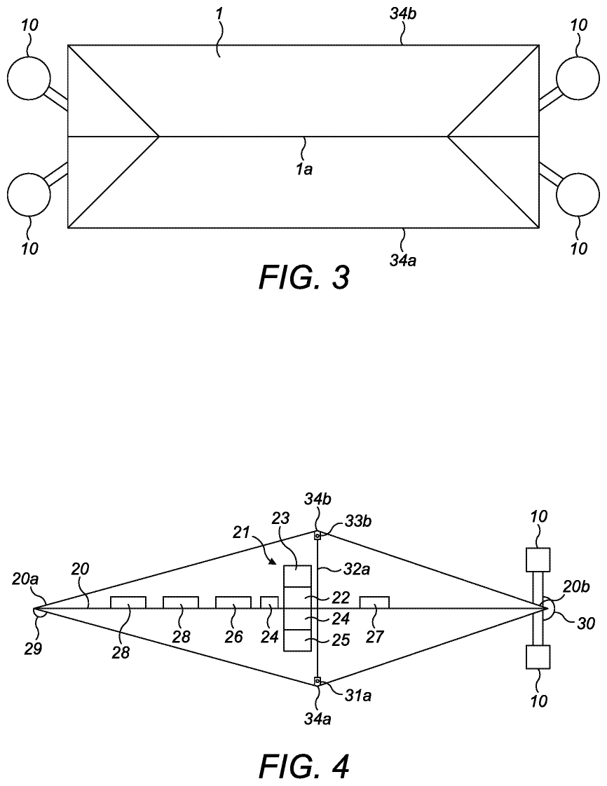

FIGS. 1 to 3 show schematic diagrams of an airship 1 according to a first embodiment. FIG. 1 is a side view of the airship 1, FIG. 2 is a plan view of the airship 1, and FIG. 3 is an end view from the front of the airship 1.

In the illustrated examples described herein the airship 1 has no crew and is intended to operate autonomously as an unmanned aerial vehicle (UAV). However, in other examples the airship 1 could be manned, carrying a human crew and/or passengers. Without being bound by theory, it will generally be expected that a manned airship 1 would generally be larger than a UAV airship because of the need to lift the human crew and/or passengers and any necessary environmental support equipment.

The airship 1 is a rigid airship having a substantially inelastic and transparent outer skin 2 supported on a rigid frame 3 to form an envelope 4. The outer skin 2 is attached to the frame 3 so that the shape of the envelope 4 is controlled by the geometry of the frame 3. The envelope 4 is sealed, and defines and encloses an interior volume. The envelope 4 contains a helium or hydrogen lifting gas filling the interior volume of the envelope 4 to provide buoyant lift so that the airship 1 can function as an aerostat.

The frame 3 of the airship 1 holds the envelope 4 in a shape comprising two rectangular based tapered sections formed by wedges 6 and 7. The two wedges 6 and 7 comprise a forward tapered wedge 6 and a rear tapered wedge 7 joined together at their respective rectangular bases 6a and 7a, which bases 6a and 7a are equal in size, with the forward tapered wedge 6 tapering towards an edge 6b forming a forward nose 1a of the airship 1 and the rear tapered wedge 7 tapering towards an edge 7b forming a rear tail 1b of the airship 1. Accordingly, the cross-sectional area of the envelope 2 is greatest at a plane 8 where the bases 6a and 7a of the wedges 6 and 7 are joined together. Thus, the cross-sectional area of the envelope at the plane 8 is the frontal area of the airship 1. The airship 1 has a longitudinal axis 9, and the envelope 2 and the wedges 6 and 7 are arranged symmetrically about the longitudinal axis 9. The use of forward and rearwardly tapering wedge shapes for the envelope 2 provides a streamlined shape of the airship, which may reduce air resistance to movement of the airship 1 relative to the surrounding air.

As is shown in FIGS. 1 to 3, the shape of the airship 1 approximates a streamlined body. The precise dimensions of the airship 1 will vary according to the specific requirements of each particular implementation. Without wishing to be bound by theory, streamlined bodies with length to diameter ratios greater than 3 are known to have a low drag coefficient for Reynolds numbers greater than about 100,000. Airships operating at 10 m/s in the stratosphere correspond to Reynolds numbers in this range to provide high net lift. To efficiently lift payloads into the stratosphere, airships should operate with low surface-area-to-volume ratios. For providing maximum net lift, a sphere is the ideal shape because the volume of contained lifting gas is relatively high compared to the mass of the skin defining the envelope. However, a sphere has relatively high drag, and its symmetry has no optimal direction for propulsion. It is expected that a good compromise between lift and drag will usually be achievable by choosing a length-to-diameter ratio between 3 and 5.

The airship 1 may be a pure airship providing lift by the displacement lift produced by the difference in density between the lifting gas and atmospheric air, or may be a hybrid airship providing lift by both displacement lift and aerodynamic lift due to differences in airflow over upper and lower surfaces of the structure of the airship 1 during powered flight of the airship 1.

The airship 1 further comprises multiple steerable electrically powered ducted fan thrusters 10 connected to the frame 3 and located symmetrically about the longitudinal axis 9 at a rear end of the airship 1. In the illustrated embodiment there are four thrusters 10, but this Is not essential. The airship 1 can be maneuvered forward or backward through the air by the thrusters 10, and will usually be driven substantially in the direction of the longitudinal axis 9, for example if the thrusters 10 are all operated to produce the same amount of thrust in an axial direction. Accordingly, the longitudinal axis 9 may also be regarded as a thrust axis of the airship 1. Further, the airship 1 can be steered in any desired direction by operation of the thrusters 10 to provide different amounts of thrust and/or thrust in different directions so that a resulting net thrust propels the airship in a desired direction and/or rotates the airship 1 about horizontal and/or vertical axes.

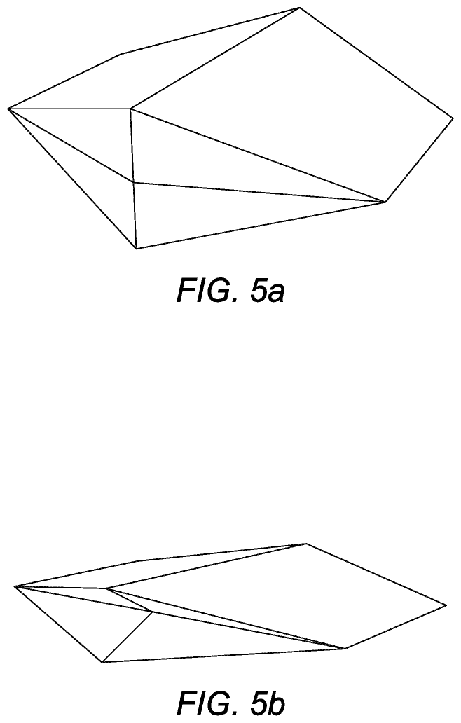

FIG. 4 shows a schematic view of components of the airship 1. The airship 1 has a support member 20 extending along the longitudinal axis 9 of the airship 1 between the nose 1a and tail 1b of the airship 1. This support member 20 acts as a keel or spine of the airship 1. The thrusters 10 are attached to the support member 20 at a rear end 20b of the support member at the tail 1b of the airship 1.

The support member 20 may be a support spar. In other examples the support member 20 may be a rod or cable.

The airship 1 includes an electronics module 21 attached to the support member 20. The electronics module 21 comprises a control unit 22, a satellite communications system 23, a battery array 24 and a first payload 25. The control unit 22 controls operation of the airship 1, and in particular operates as a flight control unit controlling flight of the airship 1. The satellite communications system 23 can support a communications link between the airship 1 and a communications satellite in orbit. Communications with the airship to ensure safe operation can additionally or alternatively be provided with other communications links, such as line-of-sight links to the ground or an aircraft, or High-Frequency skywave over-the-horizon links, or via crosslink communications with other neighboring airships, or a combination therof. The battery array 24 acts as a power supply providing electrical power to operate other parts of the airship 1, and in particular the thrusters 10, which will generally have a higher average electrical power demand than other parts of the airship.

The first payload 25 is the functional payload carried by the airship 1 to carry out assigned tasks in flight. The first payload 25 may be changed before or between airship 1 flights, and may be selected or adapted to carry out mission specific tasks on any particular airship flight. In the illustrated example the first payload 25 is a sensor system, and specifically a radar system that can support synthetic-aperture imaging and moving-target indication modes of operation. In other examples the first payload 25 may be a different sensor system or a communications system. In some examples where the first payload 25 is a sensor system, this may be located below the airship 1 in an aerodynamic fairing. This may be desirable in some examples to avoid optical sensors being impaired by absorption by the envelope 4 at the wavelength of the sensor(s) of the sensor system. Communications systems can include beyond-line-of-sight relay, cellular communications services, broadcast services, or pseudosatellite relay for power-disadvantaged ground systems

The electronics module 21 may be located at, or close to, the center of the airship 1. This may reduce the effect of yawing and pitching of the airship 1 on the satellite communications system 23 and/or the payload 25. Further, it may improve control and/or stability of the airship to have the relatively heavy components of the electronics module, particularly the battery array 24, close to the center of the airship 1. The precise location of specific components will vary in particular implementations, but the balance of the airship 1 will usually have to be taken into account when deciding component positions. Without wishing to be bound by theory, it may be preferred to locate heavier components near to the center of the airship 1. The airship 1 may be designed to accommodate multiple different payloads, although these different payloads must be consistent with the size, weight, and power limitations of the airship 1. It may be preferred to locate the payloads, whether these are located inside of, or exterior to the envelope 4, on, or close to, the center of gravity (CG) of the airship 1 so that other subsystems or components do not require position adjustments, and ballast does not need to be added, to maintain balance of the airship 1 when different payloads are used, or exchanged for one another.

Although details will vary in different implementations, in the illustrated embodiment it may commonly be found that the location of the thrusters 10 at the rear of the airship 1 will introduce clockwise (in FIG. 1) moment about the center of gravity of the airship 1, that is, this will tend to make the airship 1 tail heavy. Positioning batteries or other heavy components forward of the CG will produce a moment to balance the moment produced by the thrusters 10, allowing the airship 1 to maintain a horizontal pose.

The airship 1 further includes two GPS positioning systems 26 and 27 attached to the support member 20 at respective spaced apart positions along the longitudinal axis 9 of the airship 1. In operation of the airship 1 the control unit 22 can use position measurements from either or both of the GPS systems 26 and 27 to determine the position of the airship 1. Further, since the positions of the two GPS systems 26 and 27 are spaced apart the control unit 22 can compare the position measurements from the two GPS systems 26 and 27 to determine the orientation of the airship 1. The operation of GPS positioning systems and their use to determine position and orientation is well known, and need not be discussed in detail herein. In some examples the positioning systems 26 and 27 may make use of other GNSS services in addition to, or as alternatives to, GPS. In some examples the positioning systems 26 and 27 may combine GPS with other position measurement technologies, such as inertial measurement units and/or accelerometers in order to determine position and orientation more accurately.

The airship 1 further includes an array of steerable photovoltaic (PV) solar collectors 28 attached to the support member 20. The PV collectors 28 may be steered about two axes under the control of the control unit 22 to keep the PV collectors 28 perpendicular to incident solar radiation in order to maximize the amount of electrical power generated by the PV collectors 28. In operation of the airship 1 the electrical power generated by the PV collectors 28 may be directed under the control of the control unit 22 to power components of the airship 1, or to the battery array 24 for storage, as appropriate. The control unit 22 may steer the PV collectors 28 based on a calculated direction of incident solar radiation determined from the determined position and orientation of the airship 1 using an ephemeris table. Alternatively, or additionally, a sensor may be used to determine the direction of incident solar radiation by sensing the location of the sun. The solar collectors 28 enable the airship 1 to generate its own power, allowing the endurance of the airship 1 to be increased. Typically, the endurance of the airship 1 may be on the order of several days to several months. In some examples, light concentrators may be used with the solar collectors to improve the specific power (W/kg) of the solar power collection system. In some examples, multijunction solar collectors may be used, these may provide higher efficiency, particularly when used in combination with light concentrators.

The use of steerable PV solar collectors 28 is not essential. In some examples fixed PV solar collectors may be used. However, it is expected that the use of steerable PV solar collectors 28 will enable more solar energy to be harvested over a wider range of sun angles. This may provide the airship 1 with longer endurance and may enable use of the airship 1 across a wider range of locations and times of the year. It should be noted that the steerable PV collectors inside the airship envelope have full freedom to be steered in any direction, independently of the maneuvering of the airship. This may provide advantages in solar power collection efficiency compared to conventional solar powered UAVs mounting solar collector panels on their wings, where the direction of the collectors is generally constrained, in at least some degree, by maneuvering and aerodynamic requirements of the UAV.

In some examples the airship 1 may comprise a fuel store and an engine arranged to consume the fuel and arranged to act as a power source in addition to, or as a replacement for, the solar collectors 28 and/or the battery array 24. In some examples this may enable more effective operation of the airship 1 at night, or in conditions when insufficient solar energy is available, for example in the arctic or antarctic winter. In such examples the engine may be a fuel cell configured to generate electrical power to drive the thrusters 10 and other components of the airship 1. Fuel, such as liquid fuel, may have a higher energy density than batteries using currently available technology, so that the use of solar collectors and a small battery to power the airship 1 by day and fuel and an engine to power the airship 1 at night may allow more effective operations for an airship 1 having a particular size than a pure solar collector and battery arrangement, although the maximum endurance will be limited by the finite fuel supply.

The airship 1 further includes a second payload 29 attached to the support member 20 at a front end 20a of the support member 20 at the nose 1a of the airship 1 to carry out assigned tasks in flight. The second payload 29 may be changed before or between airship 1 flights and may be selected or adapted to carry out mission specific tasks on any particular airship flight. In the illustrated example the second payload 29 is a sensor system, and specifically an optical camera system. In other examples the second payload 29 may be a different sensor system. In some examples one of the first and second payloads 25 and 29 may be omitted if they are not required for a mission.

In some examples the second payload 29 may comprise a wind profiling sensor. As will be discussed in more detail below, knowledge of local winds at different altitudes may be desirable in order to allow the airship 1 to identify a best wind layer for the current desired movement of the airship 1 and to adjust its buoyancy to move to this altitude, as opposed to adjusting buoyancy to move through a series of altitudes and determining the wind by sensing movement of the airship 1 until an altitude having a suitable wind is found. The provision of a wind profiling sensor may enable the airship 1 to sense local winds at different altitudes.

In examples where the second payload 29 comprises a wind profiling sensor, this may make infrared Doppler radiometry measurements of pressure and temperature broadened ozone, which is most abundant in the stratosphere. The use of a narrow linewidth laser to heterodyne with the line emission signal may provide an attractive low-SWAP approach for making these measurements. However, in alternative examples other ozone lines, and/or other gases in the stratosphere, may be measured to provide wind profiling information.

The structure of the airship 1 is arranged to maintain stable flight, and stable orientation in flight, in order to provide a stable platform for the first payload 25, such as a sensor or communications system. In some examples, sensors and communications systems, such as cameras and high-bandwidth satellite communications, will require their own fine pointing and tracking subsystems to be able to provide movement relative to the structure of the airship 1 to achieve best performance. In such examples it may be preferred to carry out any orientation adjustments of the airship as a whole gradually, that is, the bandwidth of the airship control system should be small. This may allow higher bandwidth gimbals, or other mechanisms, on sensors and communications systems to operate free from competition and/or interference from platform adjustments of the orientation of the airship 1 as a whole. However, in addition to the use of the steerable thrusters 10 to maneuver the airship 1, the steerable thrusters 10 may also be used under the control of the control unit 22 to stabilize the airship 1 in some examples. Such stabilization may improve the performance of the first and second payloads 25 and 29, and the satellite communications system 23.

The airship 1 further includes a parachute 30 attached to the support member 20 at a rear end 20b of the support member at the tail 1b of the airship 1. The parachute 30 may be deployed under the control of the control unit 22 to assist in landing and recovery of the airship 1. The parachute 30 may be a parafoil.

As shown in FIG. 4, the components 21 to 28 are located inside the envelope 4 of the airship 1. This may be desirable to provide environmental protection of the components 21 to 28, and to reduce air resistance. As discussed above, the outer skin 2 of the airship 1 is transparent, so the location of the PV collectors 28 inside the envelope 4 should not significantly reduce the amount of power generated by the PV collectors 28. The outer skin 2 of the airship 1 is preferably selected to provide maximum transparency across the frequency band of maximum solar insolation intensity converted into energy by the PV collectors 28. However, in some examples it may be necessary to compromise and accept a lower transparency in this frequency band in order to obtain other desirable physical properties of the outer skin 2.

In the illustrated embodiment the first payload 25 is located inside the envelope 4 and the second payload 29 is located outside the envelope 4. This may be advantageous to allow sensors, or other payloads, which are not affected by the outer skin 2 to be located inside the envelope as the first payload 25 and to allow sensors, or other payloads, which are negatively affected by the outer skin 2 to be located outside the envelope 4 as the second payload. However, this is not essential. In other examples either of the first and second payloads 25 and 29 may be located inside or outside the envelope 4, as desired.

The airship 1 further includes an altitude control mechanism 31. In operation of the airship 1 the control unit 22 can change and control the altitude of the airship 1 by operating the altitude control mechanism 31 to change the buoyancy of the airship 1. The altitude control mechanism 31 is arranged to drive elements of the frame 3 to change the volume enclosed by the envelope 4. It will be understood that since the envelope 4 is sealed, such a change in the volume enclosed by the envelope 4 will change the pressure and density of the helium lifting gas within the envelope 4 according to the well-known universal gas law. The altitude control mechanism may be able to change the volume of the envelope 4 by a ratio of 2:1, 4:1, or more, corresponding to a range of altitude movement of 18,000 feet for each change in volume by a factor of two, this range of altitude being accessible by the change in buoyancy of the airship 1. The structure of the frame 3 and the altitude control mechanism 31 are discussed in more detail below.

When the airship 1 is neutrally buoyant at a particular altitude the lifting force generated by the buoyancy of the envelope 1 will be equal to, and balance, the weight of the airship 1. When the volume of the envelope 4 changes this will change the amount of lifting force generated by the buoyancy of the envelope 4 so that the lifting force will no longer be equal to and balance the weight of the airship 1, resulting in a vertical force which will drive the airship 1 to change in altitude until an altitude is reached where the density of the air is such that the lifting force generated by the buoyancy of the envelope 1 is again equal to, and balancing, the weight of the airship 1, and the airship 1 is restored to a state of neutral buoyancy. Although the density of the helium lifting gas within the envelope 4 changes, because the envelope 4 is sealed the total weight of the airship 1 remains constant, so that the change in lifting force is directly proportional to the change in volume of the envelope 4. That is, a specific percentage change in the volume of the envelope 4 will result in the same percentage change in the lifting force.

Accordingly, when the altitude control mechanism 31 operates to drive elements of the frame 3 to increase the volume enclosed by the envelope 4 the lifting force will increase and the airship 1 will ascend to a higher altitude. Atmospheric air density decreases with increasing altitude, and accordingly the ascent will continue until the airship 1 reaches an altitude where the air density is low enough that the lifting force generated by the buoyancy of the envelope 4 is reduced to again be equal to the weight of the airship 1. Similarly, when the altitude control mechanism 31 operates to drive elements of the frame 3 to decrease the volume enclosed by the envelope 4 the lifting force will decrease and the airship 1 will descend to a lower altitude. Atmospheric air density increases with decreasing altitude, and accordingly the descent will continue until the airship 1 reaches an altitude where the air density is high enough that the lifting force generated by the buoyancy of the envelope 4 is increased to again be equal to the weight of the airship 1.

The frame 3 and the altitude control mechanism 31 are arranged so that when the volume enclosed by the envelope 4 is changed the surface area of the envelope 4 remains substantially constant, with only minor deformations of the envelope 4 produced by the changes in internal pressure, and the frontal area of the airship changes substantially proportionally to the change in volume.

The altitude control mechanism 31 comprises two independent electrically operated winches 31a and 31b attached to the frame 3 at respective spaced apart positions along a lower edge 34a of the rectangular bases 6a and 7a of the wedges 5 and 6 where the bases 6a and 7a of the wedges 6 and 7 are joined together. The winches 31a and 31b are connected by respective cables 32a and 32b to respective spaced apart positions along an upper edge 34b of the rectangular bases 6a and 7a of the wedges 5 and 6 where the bases 6a and 7a of the wedges 6 and 7 are joined together. By operating the winches 31a and 31b to retract the respective cables 32a and 32b the upper and lower edges 34a and 34b of the wedges 6 and 7 can be moved closer together, reducing the volume enclosed by the envelope 4 and increasing the pressure of the helium lifting gas. Further, by operating the winches 31a and 31b to extend the respective cables 32a and 32b the upper and lower edges 34a and 34b of the wedges 6 and 7 can be allowed to move further apart, urged by the pressure of the helium lifting gas, increasing the volume enclosed by the envelope 4 and decreasing the pressure of the helium lifting gas. The winches 31a and 31b may be driven independently or together by a single motor, in the same or different directions, through a clutch or similar mechanical arrangement. Alternatively, the winches 31a and 31b may be driven by separate respective motors.

The use of two winches is not essential. In other examples a different number of winches, for example three, four, or more winches may be used. In an example with four winches the different winches may, for example, comprise two winches operated differentially to control right and left side symmetry, and two winches operated differentially to control front and back balance. Operated together these four winches control the compression of the envelope 4.

During operation of the winches 31a and 31b, respective winch positions are determined by the use of distance sensors and/or by counting the amount of cable 32a, 32b moved by each winch 31a and 31b. In some examples a distance sensor is mounted adjacent to each winch 31a, 31b pointing at the opposite surface, in the illustrated example the point on the upper edge 34b where the cables 32a and 32b are connected, to measure that distance. A counting sensor is mounted on each winch 31a, 31b to count marks on either the cable 32a, 32b or some other part of the winch assembly to determine what length of each cable 32a, 32b has been wound or unwound. The control system uses this information to accurately control the volume and shape of the envelope.

In the illustrated example the winches 31a and 31b are mounted inside the envelope 4. In other examples winches could be located instead on the exterior of the airship structure. Exterior winches could actuate over a longer moment arm, providing greater mechanical advantage to volume control. However, the use of exterior winches could result in increased drag and may be more vulnerable to the environment.

The orientation of the airship 1 in space during the operation of the winches 31a and 31b to change the volume of the envelope 4 is maintained by providing one or more accelerometers and/or gyroscopes. Orientation information from these is provided to the control system, which uses this information as a basis to operate the winches 31a and 31b to maintain the desired orientation by compressing or expanding the envelope asymmetrically to change the balance, resulting in a change in roll or pitch due to the force of the lifting gas which maintains the airship 1 stably in a desired orientation.

The side edges 34c and 34d of the rectangular bases 6a and 7a of the wedges 5 and 6 where the bases 6a and 7a of the wedges 6 and 7 are joined together are arranged so that when the upper and lower edges 34a and 34b are at their maximum separation, and the volume enclosed by the envelope is at a maximum the edges 34c and 34d are substantially straight so that the respective rectangular bases 6a and 7a are rectangular. This configuration where the volume enclosed by the envelope is at a maximum is shown in FIGS. 1 to 3.

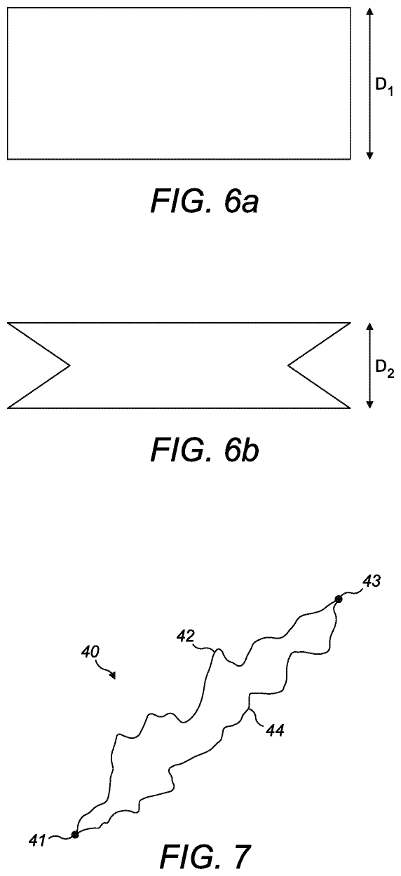

FIG. 5a shows the shape of the envelope 4 when the volume enclosed by the envelope is at a maximum, and FIG. 6a shows a cross-section through the envelope 4 at the plane 8. Other parts of the airship 1 are omitted for clarity. As can be seen in FIG. 5a, in this configuration the two tapered wedges 6 and 7 have substantially flat side faces and their bases 6a and 7a are rectangular, with the upper and lower edges 34a and 34b at their maximum separation D₁. This configuration corresponds to the airship 1 having neutral buoyancy at a maximum altitude for its current weight. This maximum altitude at which the airship 1 has neutral buoyancy is not necessarily the maximum altitude the airship 1 can reach, as it may be possible to drive the airship 1 to a higher altitude using aerodynamic lift and/or thrust from the thrusters 10.

FIG. 5b shows the shape of the envelope 4 when the volume enclosed by the envelope has been reduced, and the pressure of the helium lifting gas increased, by the winches 31a and 31b retracting the cables 32a and 32b and moving the upper and lower edges 34a and 34b of the wedges 6 and 7 closer together, and FIG. 6b shows a cross-section through the envelope 4 at the plane 8. As can be seen in FIG. 5b, in this configuration the two tapered wedges 6 and 7 have substantially concave side faces which are folded inwardly, with the upper and lower edges 34a and 34b at a separation D₂ smaller than their maximum separation D₁. This configuration corresponds to the airship 1 having neutral buoyancy at an altitude lower than the maximum altitude of the configuration of FIG. 5a.

The use of two independent winches 31a and 31b in the altitude control mechanism is not essential, and a single winch, or more than two winches may be used in other examples. However, it may be advantageous to have multiple independent winches in order to allow winches to be controlled to correct for any mechanical differences in the operation of different parts of the frame, for example some frame joints having higher friction than others, to keep the shape of the envelope 4 symmetrical and the airship 1 balanced.

The airship 1 having a structure whereby the volume enclosed by the sealed envelope 4 may be changed while the surface area of the envelope 4 remains constant and the frontal area of the airship changes substantially proportionally to the change in volume may provide a number of advantages.

As explained above, the capability to change the volume of the sealed envelope 4 enables the airship 1 to change in buoyancy without any change in weight. Accordingly, the airship 1 can change altitude in either direction by changing the volume of the sealed envelope 4 without any requirement to drop ballast or release lifting gas. The amount of ballast and replacement lifting gas carried by an airship is finite, so that the capability to change altitude without dropping ballast or releasing lifting gas may increase the endurance of the airship 1. Further, the lifting efficiency of the airship 1 may be increased by removing or reducing the requirement to carry ballast and/or reserve lifting gas.

Some rigid airships control buoyancy and altitude using interior ballonets within a fixed envelope defined by a fixed frame. The air drag force experienced by a small airship is, generally proportional to the frontal area (maximum cross-sectional area) of the airship and to the air density, while the drag force experienced by large airships is generally proportional to Volume^{2/3} and to the air density. It is expected that the airship of the illustrated embodiment will have a drag force between these two extremes. As a result, the propulsive efficiency of an airship is at a maximum at a designed maximum altitude. At lower altitudes the air density is greater, so that the air drag is increased. In contrast, in the illustrated embodiment the frontal area of the airship 1 changes substantially proportionally to the change in volume, so that at lower altitudes, where the volume of the envelope 4 is reduced, the air density is greater and the frontal area of the airship 1 is reduced. As is discussed above, the change in air density and the change in frontal area of the airship 1 at different altitudes are inversely proportional, so that the air drag of the airship 1 will tend to be approximately constant at all altitudes. Further, this constant air drag at all altitudes of the airship 1 will be approximately the same as the air drag of a conventional airship operating at its most efficient designed maximum altitude. Accordingly, the airship 1 may have improved propulsive efficiency over a range of altitudes.

Having the volume enclosed by the sealed envelope 4 able to be changed while the surface area of the envelope 4 remains constant avoids any requirement to deal with excess material removed from or added to the envelope 4 as the volume of the envelope 4 changes, which may be difficult. It will be understood that although there are multiple ways to compress the volume of an envelope structure these will generally result in a change in surface area resulting in excess material when the volume is reduced form a maximum. For example, a cylinder could be rolled up like a scroll. However, frictional forces associated with the rolling mechanism over a large surface area will likely be large, so this approach is not preferred. Similarly, a cylinder could be twisted to reduce its area (length may change depending on the pitch of the fabric envelope). However, such an arrangement may require mechanisms at each end of the cylinder which may be bulky. A structure could be pinched, but excess material would need to be managed in a series of pleats which may impede airflow over the surface. All of these methods reduce cross section to produce the desired volume change and therefore could in principle provide for efficient propulsion over a range of altitudes. Alternatively, the airship could be compressed from front to back, like an accordion. This would introduce volume change, but the decreased length-to-diameter ratio at lower altitudes would likely contribute to increased drag. Accordingly, the approach as used in the illustrated embodiment of folding the material like a bellows is preferred to produce a change in cross section while preserving desirable streamlined airflow over the structure The list above of possible arrangements is not intended to be exhaustive.

FIG. 7 shows a diagrammatic example of a possible mission profile 40 for the airship 1.

As shown in FIG. 7, the airship 1 is launched from the ground at a launch location 41, and then travels along an outward path 42 to a desired operating location 43. The airship 43 remains at the operating location 43 for a period of time. The airship 1 then travels along a return path 44 back to the launch location 41 and is landed and recovered.

Typically, the airship 1 may be able to remain at the operating location for an extended period of time, for example 30 to 60 days.

Typically, in examples where the airship 1 is to be launched from the ground the airship 1 will arrive at the launch location 41 uninflated and in a folded or disassembled transport configuration to ease transport and handling. The airship 1 is then unfolded and/or assembled as necessary to place the airship 1 in a flight configuration and inflated with lifting gas. In some examples the airship 1 may be transported without any payload, and a desired payload may be fitted to the airship 1 as part of the launch procedure. This may reduce costs and simplify logistics by allowing a fleet of standardized general purpose airships 1 to be used, with the airships being provided with mission specific payload(s) on an as-needed basis.

In other examples the airship 1 may be launched from a waterborne vessel, or an aircraft. In some examples the airship 1 may be packaged in a container or package containing a pressurized container or chemical composition arranged to release lifting gas to fill the airship envelope to enable deployment of the airship 1 from the package. This deployment may be carried out automatically, enabling the airship 1 to be launched on command from a predeployed location on land or water, or even to carry out a mid-air deployment from an airdropped package.

In the illustrated example the payload 25 of the airship 1 is an optical sensor and the mission is for the airship 1 to remain overhead of the operating location 43 to keep the operating location 43 under surveillance for a predetermined length of time, and to report the results of the surveillance to a communications satellite in orbit, or through some other communications system.

The airship 1 is intended to operate in the stratosphere at altitudes in the range of 15-26 km above sea level. Accordingly, the altitude control mechanism 31 is arranged to change the volume of the envelope 4 sufficiently to allow the airship 1 to have a neutral buoyancy at any specific altitude in this altitude range. Thus, the airship 1 can travel to and remain at any altitude in this range by operation of the altitude control mechanism 31. Operation at such a high altitude may make the airship 1 relatively unobtrusive and hard to detect. Further, operation at such a high altitude may provide the airship 1 with a good field of view for the optical sensor, and any other sensor payloads, or may provide a good line of sight for communications by any communications payload. Further, operation at such a high altitude may make the airship 1 difficult to attack or harm even if it is detected.

In other examples the airship 1 may be arranged to operate at a different range of altitudes, for example 17-20 km or 14-30 km above sea level.

It is known that winds at any particular location are generally not constant at all altitudes and that winds travelling in different directions at different speeds may usually be found at different altitudes over the same location. Indeed, it is common for there to be winds with directions that differ by at least 180° at different attitudes over the same location.

After launch, the airship 1 ascends quickly to its intended altitude range. Any suitable launch technique may be used. Launch techniques for stratospheric balloons and airships are well known, and so need not be described in detail herein.

The control unit 22 of the airship 1 then navigates the airship 1 autonomously towards the operating location 43 along the outward path 42. During this autonomous navigation the airship 1 attempts to identify favorable winds which will tend to propel the airship 1 towards the operating location 43 and uses the altitude control mechanism 31 to ascend or descend as necessary to the correct height to ‘catch’ and ride the identified favorable winds. This may enable the airship 1 to arrive at the operating location 43 more quickly and/or with the expenditure of less energy on propulsion, than travelling at a constant altitude. As a result of this process of using the available winds to assist travel the outward path 42 will generally not be a straight path, but may be rather convoluted, as shown in FIG. 7. In locations where no favorable winds which will propel the airship 1 towards the operating location 43 can be identified, the airship 1 uses the altitude control mechanism 31 to ascend or descend as necessary to catch the wind which will tend to propel the airship 1 away from the operating location 43 the least, which may be regarded as the most favorable (or least unfavorable) wind available in this situation.

The control unit 22 may identify favorable winds in any convenient manner. In the illustrated embodiment the airship 1 is provided with a current atmosphere wind model for a planned operating area before launch. The airship 1 may be provided with updated wind information to update the wind model during the mission. Such updated wind information may, for example, be transmitted to the airship 1 by ground stations, satellites, and/or aircraft, including other airships. In particular, such updated wind information may be provided from ground stations, such as the launch location 41, based on wind measurements using radiosondes and/or scout balloons. Radiosondes are instrumented balloons which ascend until they burst. Scout balloons are instrumented balloons which release ballast and lifting gas in order to ascend and descend over time. However, in practice such wind information from sources remote from the airship 1 may have insufficient detail regarding wind conditions close to the airship 1 for optimal identification of favorable winds. Accordingly, it may be desirable for the airship 1 to sense local wind conditions itself.

The airship 1 may determine the wind direction and speed at different altitudes directly by ascending and/or descending to traverse in height across the altitude range of the airship 1. At any particular height the wind direction and speed can be determined by comparing the air speed of the airship 1 to the ground speed of the airship 1. The airspeed of the airship 1 may be deduced from the current thrust power and direction of the thrusters 10, or may be measured using conventional flight instrumentation, such a pitot heads and/or doppler laser devices. The ground speed of the airship 1 can be determined from the changes over time of the position of the airship 1 as determined by the GPS systems 26 and 27.

In some examples the airship 1 may be provided with one or more sensors to determine wind speed and direction in the vicinity of the airship 1. One possible sensor would be for the airship to release pellets adapted to travel upward or downward and track the movement of the pellets as they rise or fall. Such pellets could, for example, be fluorescent or contain light emitters, and be tracked by a suitable camera and telescope. Possible sensors to remotely sense wind conditions include lidar and gas spectroscopy based sensors.

When the airship 1 arrives at the operating location 43, control unit 22 of the airship 1 then navigates the airship 1 autonomously to station keep at the desired location 43. That is, to maintain, as far as possible, a fixed position over the operating location 43, or as close as possible to the operating location 43. It will be understood that station keeping at a fixed position for an airship operating at a fixed altitude is relatively straightforward, the airship turns to face into the current wind and applies enough engine power that the airspeed of the airship matches the wind speed, so that the groundspeed of the airship remains substantially zero. In the event that the windspeed exceeds the airships maximum airspeed the airship will be blown off station.

The airship 1 follows a similar procedure, with the additional feature that the airship 1 attempts to identify wind speed and direction at different heights at the location of the airship 1, that is, usually the operating location 43, and uses the altitude control mechanism to 31 to ascend or descend to as necessary to a height where the wind speed is relatively low. If possible, the airship 1 should move to a height where the wind speed is lower than the maximum airspeed of the airship 1, so that the airship 1 can maintain a position at the operating location 43. Further, if there is more than one height where the wind speed is lower than the maximum airspeed of the airship 1, the airship 1 should move to the altitude having the lowest windspeed, in order to minimize the amount of driving power required by the thrusters 10 in order for the airship 1 to maintain a position at the operating location 43.

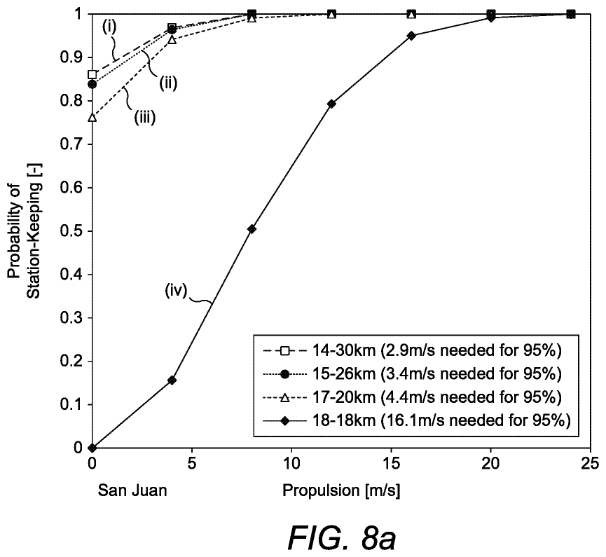

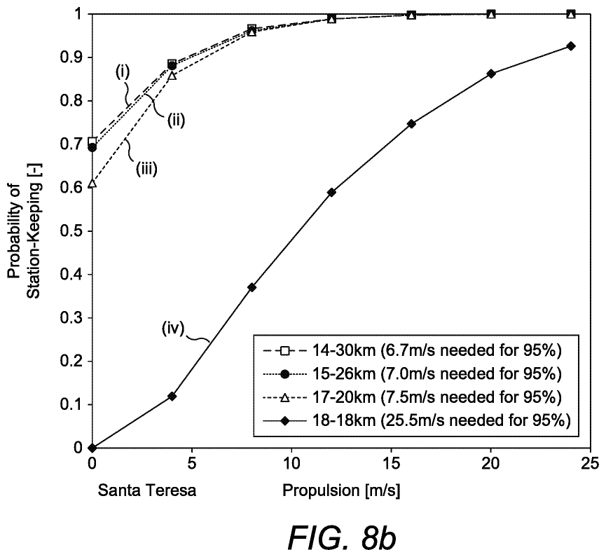

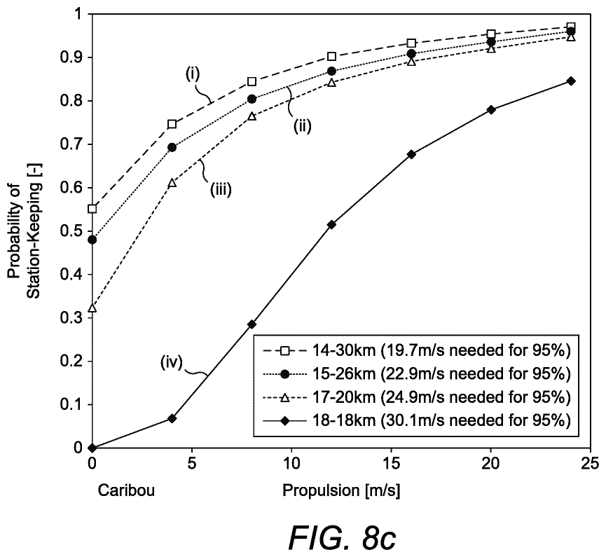

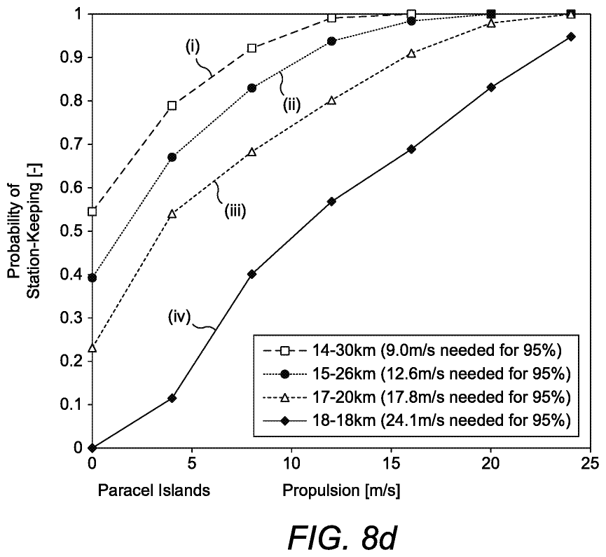

FIGS. 8A to 8D show graphs based on recorded wind data at four respective different locations. Each of FIGS. 8A to 8D indicates, for the respective location a graph of the maximum airspeed an airship propulsion system can provide against the probability, based on the recorded wind data at that location, of successful station keeping by the airship, in other words, the probability that the airship can maintain position over a fixed point.

In each of FIGS. 8A to 8D a line is plotted for (i) an airship having an altitude range 14-30 km, (ii) an airship having an altitude range 15-26 km, (iii) an airship having an altitude range 17-20 km, and (iv) a conventional fixed altitude airship operating at an altitude of 18 km.

As can be seen in all of FIGS. 8A to 8D, for an airship having a specific maximum airspeed, the larger the altitude range the airship can operate over, the greater the probability of successful station keeping by that airship. Similarly, for an airship to have a specific probability of successful station keeping, the larger the altitude range the airship can operate over, the lower the necessary maximum airspeed of the airship.

Table 1 shows for each of the four locations and each of the four airships having different altitude ranges of FIGS. 8A to 8D, the maximum airspeed required in meters per second, and the power consumed for propulsion, in order for an airship at that location to have a 95% probability of successful station keeping. The power consumed for propulsion Is shown as a percentage relative to the power consumed for propulsion by the conventional fixed altitude airship.

As can be seen in table 1, the airships according to the present disclosure able to operate at a range of altitudes require significantly lower maximum air speeds and power, in many examples consuming only 5% or less of the power of a conventional fixed altitude airship.

TABLE 1

| | San Juan, | | Santa | | Caribou, | | Paracel | |
|---|---|---|---|---|---|---|---|---|
| | Puerto Rico | | Teresa, NM | | ME | | Islands | |
| | m/s | % Power | m/s | % Power | m/s | % Power | m/s | % Power |
| 14-30 km | 2.90 | 0.77 | 6.70 | 4.25 | 19.7 | 28.03 | 9.00 | 5.21 |
| 15-26 km | 3.40 | 1.24 | 7.00 | 4.85 | 22.9 | 44.04 | 12.60 | 14.29 |
| 17-20 km | 4.40 | 2.68 | 7.50 | 5.96 | 24.9 | 56.61 | 17.80 | 40.29 |
| 18 km | 14.70 | 100.00 | 19.20 | 100.00 | 30.1 | 100.00 | 24.10 | 100.00 |

The reduction in the maximum airspeed required for an airship to have a desired probability of station keeping may provide the advantage of reducing the size, weight and cost of the thrusters, or other propulsion system of the airship 1. This may allow the payload weight to be increased and/or the total size and cost of the airship 1 to be reduced. The reduction in the total power required for an airship to have a desired probability of station keeping may also provide the advantage of reducing the size, weight and cost of the batteries or other energy storage means. This, too may allow the payload weight to be increased and/or the total size and cost of the airship 1 to be reduced. Further, the reduction in the power required for an airship to have a desired probability of station keeping may provide the advantage of increasing endurance, and potentially increasing endurance indefinitely if the power required can be reduced below the amount of power which can be supplied by the PV panels, or other on-board energy harvesting means.

When the predetermined length of time assigned for surveillance of the operating location 43 expires, the control unit 22 of the airship 1 then navigates the airship 1 autonomously back towards the launch location 41 along the return path 44.

During this autonomous navigation the airship 1 attempts to identify favorable winds which will tend to propel the airship 1 towards the launch location 41 and uses the altitude control mechanism 31 to ascend or descend as necessary to the correct height to ‘catch’ and ride the identified favorable winds. This may enable the airship 1 to arrive at the launch location 41 more quickly and/or with the expenditure of less energy on propulsion, than travelling at a constant altitude. As a result of this process of using the available winds to assist travel the return path 44 will generally not be a straight path, but may be rather convoluted, and the return path 44 will generally not be the same as the outward path 42, as shown in FIG. 7. This is particularly the case or maneuvers that take place over multiple days because the winds may be expected to shift over such extended time frames. Accurate forecasts of changing winds will generally improve the efficiency and effectiveness of navigation by the airship 1.

On return to the launch location 41 the airship 1 descends to a suitably low altitude using the altitude control mechanism 31 and carries out a controlled landing or low altitude hover at the launch location 41, where ground handler(s) can secure and recover the airship 1 for re-use of some, or all of the airship 1. In some examples only the payload is re-used, and in other examples the airship 1 as a whole may be re-used. It will be understood that even when the airship 1 as a whole is not re-used, parts and components of the airship 1 may be removed for re-use. In some examples the airship 1 may further also vent some or all of the lifting gas from the envelope 4 as part of a controlled landing.

In other examples, the airship 1 may return to the launch location 41 and then release all of the lifting gas, for example by ripping open the envelope 4, and deploying the parachute 9 to make a controlled descent of the airship 1 to the ground. The airship 1 can then be recovered for re-use. In other examples the parachute 9 may be arranged to carry only the payload in a controlled descent for recovery and re-use, while the remainder of the airship 1 is abandoned. However, for both economic and environmental reasons, it is expected that it will usually be preferred to recover the entire airship 1 for at least partial re-use.

In the illustrated example of FIG. 7 the airship 1 returns to the launch location 41 at the end of the mission. This is not essential. In other examples the airship 1 may proceed to a different location for recovery at the end of the mission, so that the airship 1 travels between a launch location and a recovery location during the flight. In some examples the recovery location may be changed during a mission, for example in response to changes in weather conditions.

In the first embodiment the first and/or second payloads 25 and 29 may be any type of sensor or communication device. For example, the payload(s) may be a sensor, for example a radar, a low size-weight-power-cost (swap-c) radar, a SAR radar, and/or a lidar. The payload(s) may be an imager, for example an electro-optic infra-red (EOIR) imager, which may be combined with wide-area motion imagery (WAMI) for cued lightweight reflective optics. The payload(s) may be acoustic/infrasound sensors, passive RF sensors, electronc warfare (EW) systems, position, navigation and timing (PNT) sensors, or pseudolites to augment GPS, etc. The payload(s) may be communications equipment, for example, local telecoms relays, beyond line of sight (BLOS) relays, or long-distance low-latency communications relays.

The first embodiment has been described above in terms of a single airship 1.

In a second embodiment a formation of airships 1 may be used.

It will be understood that an affordable airship design, such as the illustrated first embodiment, allows for the affordable use of a network and/or formation of airships. Networks and/or formations may offer extended area coverage or fly in close formation to provide optimized coverage of a desired region. Such a close formation cannot be achieved with altitude-control balloons, which tend to drift apart carried by the winds. Such a distributed network of multiple airship platforms cannot be implemented practically using traditional airships due to the cost of each platform.

The airship of the first embodiment can find the most favorable wind layers and maintains its altitude where it can use those winds to its best advantage. This contrasts with conventional solar powered UAVs which have to rise to their highest attainable altitude during daytime in order to avoid descending below a minimum safe altitude when they are forced to glide at night. Solar powered UAVs are forced to glide at night because they are not able to collect solar power and have insufficient stored power for continuous powered flight due to the limitations of battery capacity. As a result, solar powered UAVs are exposed to whatever winds they encounter at the different altitudes they traverse while gliding at night.

One situation where a formation of airships 1 may advantageously be used is where the airships 1 carry respective synthetic aperture radar (SAR) systems. A formation of airships 1 in cooperation can collect the required data to form an SAR image more quickly than a single airship 1. The use of multiple platforms may also improve the geolocation accuracy of moving-target-indicator (MTI) radars or of signals intelligence receivers. RF or acoustic beamforming techniques using sparse arrays distributed among multiple platforms can provide improved gain in preferred directions and form nulls to reject interference from other directions.

Another situation where a formation of airships 1 may be used is where the airships 1 carry respective communications systems which cooperate to provide communications services. In one example the respective communications systems of the different airships may cooperate to form a beamforming array for communications signals.

Another situation where a formation of airships 1 may be useful is where the prevailing winds are such that although an airship 1 has a maximum airspeed greater than is required for station keeping in daylight, the power capacity of the airships battery array 24 is not sufficient for the airship 1 to continue station keeping overnight when the PV collectors 28 are unable to harvest power. In this situation an airship can follow a sprint and drift profile where the airship ‘sprints’ at an airspeed high enough to move the airship 1 upwind relative to a desired location during the day, when sufficient power is available, and then to ‘drift’ downwind relative to the desired location during the night, where airspeed is limited by the available power. Sprint and drift has been used to enable power-efficient day/night station keeping by a single airship, but this approach has not been used for formations of multiple airships.

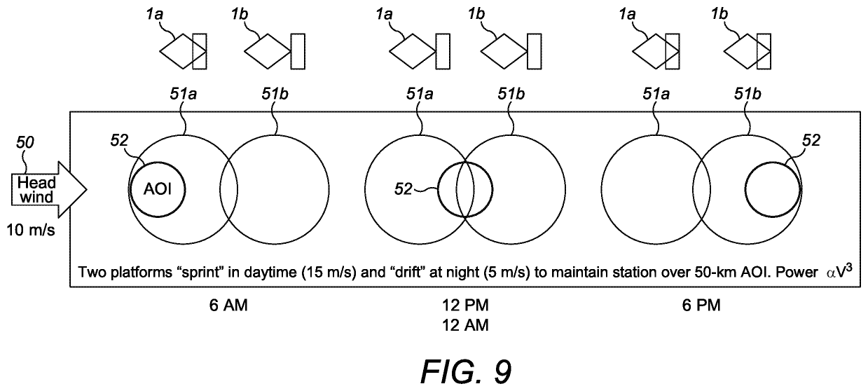

In this situation, a pair of airships 1a and 1b may be used, as shown schematically in FIG. 9. The airships 1a and 1b are arranged in formation in the direction 50 of the prevailing wind. Each airship 1a and 1b has a sensor system with a respective field of view 51a, 51b. The airships 1a and 1b are maneuvered so that an area of interest (AOI) 52 to be kept under surveillance by the airships 1a and 1b is within the field of view 51a of the upwind airship 1a at first light, as shown in the left hand part of FIG. 9 showing the situation at 6 AM. During the day the two airships 1a and 1b travel at an airspeed greater than the windspeed, maintaining formation, and moving upwind relative to the AOI 52, as shown in the center part of FIG. 9 showing the situation at 12 AM. The airships 1a and 1b reach a position by nightfall where the AOI 52 is within the field of view 51b of the downwind airship 1b, as shown in the right hand part of FIG. 9 showing the situation at 6 PM. Then, during the night, the two airships 1a and 1b travel at an airspeed lower than the windspeed, to conserve power. maintaining formation, and moving downwind relative to the AOI 52, as shown in the center part of FIG. 9 showing the situation at 12 PM, eventually returning to the first light position as shown in the left hand part of FIG. 9.

Accordingly, the formation of two airships 1a and 1b is able to maintain continuous surveillance of the AOI 52 despite the fact that the airships 1a and 1b cannot individually station keep continuously over the AOI 52.

Similarly, if the formation of two airships 1a and 1b were carrying communications payload they could maintain continuous communications connectivity across the AOI 52.

Another situation where a formation of airships 1 may be used is to carry out surveillance across a large area. In this case a two dimensional array formation of airships 1 may be arranged to cover the entire area.

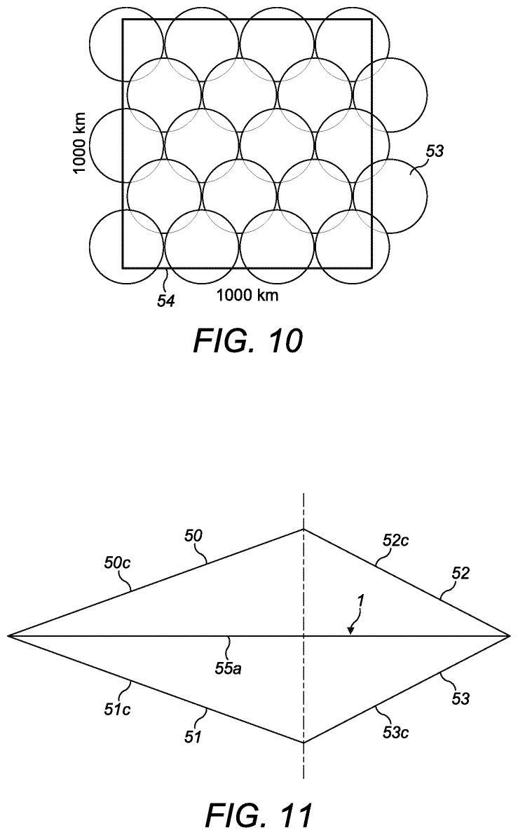

FIG. 10 shows an array of areas 53 of coverage of a formation of airships 1 in an array. The array of areas of coverage 53 collectively cover an extended area of interest 54, in the illustrated example a square 1000 km on a side.

An array formation of airships 1 may include additional airships to extend the area collectively covered by the areas of coverage 53 of the array across a larger area than the extended area of interest 54. This additional coverage area may enable a sprint and drift procedure to be used by the array formation of airships 1.

The array formation of airships may have a single lead airship 1 which maneuvers to travel or station keep as required, with the remaining airships of the formation maneuvering to maintain a fixed position relative to the lead airship.

In some examples a station keeping strategy may be used for a formation of airships which allows airships to maintain relative position to a leader. However, in the process of doing so, the airships should jointly manage their power resources so that no single airship is required to disproportionately expend power to make adjustments to its position relative to another airship, since this could exhaust that airships power and cause that airship to be lost from the formation. In some examples an autonomous station-keeping algorithm may manage power consumption across all airships in a formation.

In some examples a formation of airships 1 may include, or be accompanied by one or more wind scout airships 1 which ascend and/or descend to traverse in height across the altitude range of the airships 1 to identify wind speed and direction at different altitudes and report this to the other airships 1 in the formation.

In some examples the airships 1 of a formation of airships may comprise respective communication systems arranged to cooperate to provide communications between different ones of the airships 1 in the formation of airships. These communications may be by direct communications links between the airships, by relay through intervening airships in the formation of airships, or by relay through other intervening platforms, such as a satellite or a ground station.

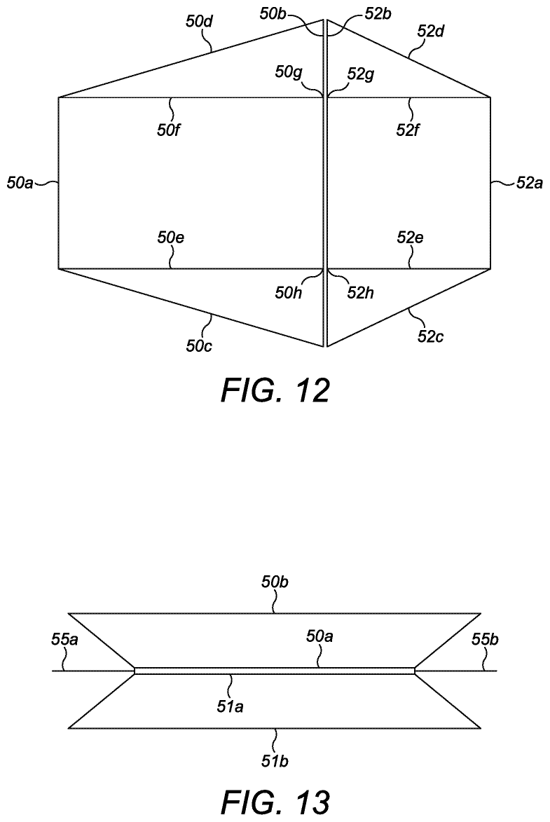

FIGS. 11 to 13 show diagrams of the frame 3 of the airship 1 according to the first embodiment. FIG. 11 is a side view of the frame 3, FIG. 12 is a plan view from above of the frame 3, and FIG. 13 is an end view of the frame 3 from the front of the airship 1.

The frame 3 comprises first to fourth trapezoids 50 to 53. The forward tapered wedge 6 is formed by opposed first upper and second lower trapezoids 50 and 51, and the rear tapered wedge 7 is formed by opposed third upper and fourth lower trapezoids 52 and 53.

The first trapezoid 50 comprises a front strut 50a and a rear strut 50b parallel to the front strut 50a and longer than the front strut 50a. Ends of the front and rear struts 50a and 50b are linked by a pair of opposed inclined side struts 50c and 50d attached to respective opposite ends of the front and rear struts 50a and 50b. The front and rear struts 50a and 50b are further linked by a pair of parallel spaced apart struts 50e and 50f, which are attached at respective opposite ends to the front strut 50a and to the rear strut 50b. As is shown in FIG. 12, since the rear strut 50b is longer than the front strut 50a the pair of parallel spaced apart struts 50e and 50f are attached to the rear strut 50b at respective positions 50g and 50h spaced from the ends of the rear strut 50b where the side struts 50c and 50d are attached.

Similarly, the second trapezoid 51 comprises a front strut 51a and a rear strut 51b parallel to the front strut 51a and longer than the front strut 51a. Ends of the front and rear struts 51a and 51b are linked by a pair of opposed inclined side struts 51c and 51d attached to respective opposite ends of the front and rear struts 51a and 51b. The front and rear struts 51a and 51b are further linked by a pair of parallel spaced apart struts 51e and 51f, which are attached at respective opposite ends to the front strut 51a and to the rear strut 51b. Since the rear strut 51b is longer than the front strut 51a the pair of parallel spaced apart struts 51e and 51f are attached to the rear strut 51b at respective positions 51g and 51 h spaced from the ends of the rear strut 51b where the side struts 51c and 51d are attached. The second trapezoid 51 is not visible in FIG. 12 because it is located beneath the first trapezoid 50.

The third trapezoid 52 comprises a rear strut 52a and a front strut 52b parallel to the rear strut 52a and longer than the rear strut 52a. Ends of the front and rear struts 52b and 52a are linked by a pair of opposed inclined side struts 52c and 52d attached to respective opposite ends of the front and rear struts 52b and 52a. The front and rear struts 52b and 52a are further linked by a pair of parallel spaced apart struts 52e and 52f, which are attached at respective opposite ends to the front strut 52b and to the rear strut 52a. As is shown in FIG. 12, since the front strut 52b is longer than the rear strut 52a the pair of parallel spaced apart struts 52e and 52f are attached to the front strut 52b at respective positions 52g and 52h spaced from the ends of the front strut 52b where the side struts 52c and 52d are attached.

The fourth trapezoid 53 comprises a rear strut 53a and a front strut 53b parallel to the rear strut 53a and longer than the rear strut 53a. Ends of the front and rear struts 53b and 53a are linked by a pair of opposed inclined side struts 53c and 53d attached to respective opposite ends of the front and rear struts 53b and 53a. The front and rear struts 53b and 53a are further linked by a pair of parallel spaced apart struts 53e and 53f, which are attached at respective opposite ends to the front strut 53b and to the rear strut 53a. Since the front strut 53b is longer than the rear strut 53a the pair of parallel spaced apart struts 53e and 53f are attached to the front strut 53b at respective positions 53g and 53h spaced from the ends of the front strut 53b where the side struts 53c and 53d are attached. The fourth trapezoid 53 is not visible in FIG. 12 because it is located beneath the third trapezoid 52.

The front struts 50a and 51a of the first and second trapezoids 50 and 51 are pivotally attached together, as are the rear struts 52a and 53a of the third and fourth trapezoids 52 and 53. The rear strut 50b of the first trapezoid 50 is pivotally connected to the front strut 52b of the third trapezoid 52, similarly, the rear strut 51b of the second trapezoid 51 is pivotally connected to the front strut 53b of the fourth third trapezoid 53.

The winches 31a and 31b of the altitude control mechanism 31 are respectively connected to the frame 3 at the points where the struts 51e and 51f contact the rear strut 51b and the struts 53e and 53f contact the front strut 53b. The cables 32a and 32b are respectively connected to the frame 3 at the points where the struts 50e and 50f contact the rear strut 50b and the struts 52e and 52f contact the front strut 52b.

A first side strut 55a extends along a first side of the frame 3 and is connected between first ends of the front struts 50a and 51a of the first and second trapezoids 50 and 51 and first ends of the rear struts 52a and 53a of the third and fourth trapezoids 52 and 53. A second side strut 55b extends along a second side of the frame 3 opposite the first side and is connected between second ends of the front struts 50a and 51a opposite their first ends and second ends of the rear struts 52a and 53a opposite their first ends. The first and second side struts are curved, or articulated, to substantially follow the side profiles of the first to fourth trapezoids 50 to 53. The frame 3 is attached to the support member 20 at the centers of the front struts 50a and 51a and the centers of the rear struts 52a and 53a.

When the volume of the envelope 4 is to be reduced the winches 31a and 31b are operated to retract the cables 32a and 32b and so pull the rear strut 50b of the first trapezoid 50 and the front strut 52b of the third trapezoid 52 towards the rear strut 51b of the second trapezoid 51 and the front strut 53b of the fourth third trapezoid 53, decreasing the height of the frame 3 and the envelope 4. As the height of the frame 3 decreases the length of the frame 3 increases, and the front struts 50a and 51a of the first and second trapezoids 50 and 51 move further away from the rear struts 52a and 53a of the third and fourth trapezoids 52 and 53, for geometrical reasons. Accordingly, as a result of this increase in length, the first and second side struts 55a and 55b are pulled inwardly, causing the sides of the envelope 4 to fold inward.

This process is reversed to increase the volume of the envelope.

In order to accommodate the change in length of the frame 3 the rear end of the frame 3 is arranged for axial movement relative to the support member 20. This is not essential, in alternative examples the front end of the frame 3 could be arranged for axial movement relative to the support member 20, or the support member 20 may be arranged to change in length.

The frame 3 of FIGS. 11 to 13 can be folded substantially flat, subject to the space required by any internal components of the airship 1 within the envelope. The ability to fold the frame flat may simplify transport and storage of the airship 1 when not in use.

The struts of the frame 3 may be made from carbon fiber, as this is a lightweight and rigid material. However, other suitable materials may be used.

In the first embodiment described above the airship 1 has a position along its length where the frame 3 is driven to change the volume of the envelope. This position may be referred to as a ‘pinch point’, although there may be more than one location where the driving force is applied.

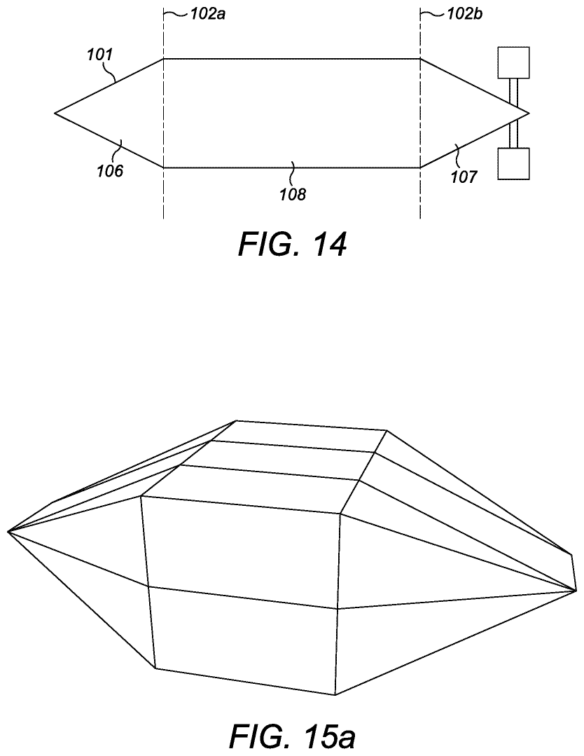

FIG. 14 shows a side view of an airship 101 having two such pinch points 102a and 102b at spaced apart locations along its length. This may be regarded as a design having three segments, in contrast to the airship 1, which is a design having two segments. The frame of this airship 101 holds an envelope 104 in a shape comprising two rectangular based tapered sections formed by wedges 106 and 107 separated by a section 108 having a constant cross-section. The two wedges 106 and 107 comprise a forward tapered wedge 106 and a rear tapered wedge 107 joined together at their respective rectangular bases, which are equal in size, by the section 108.

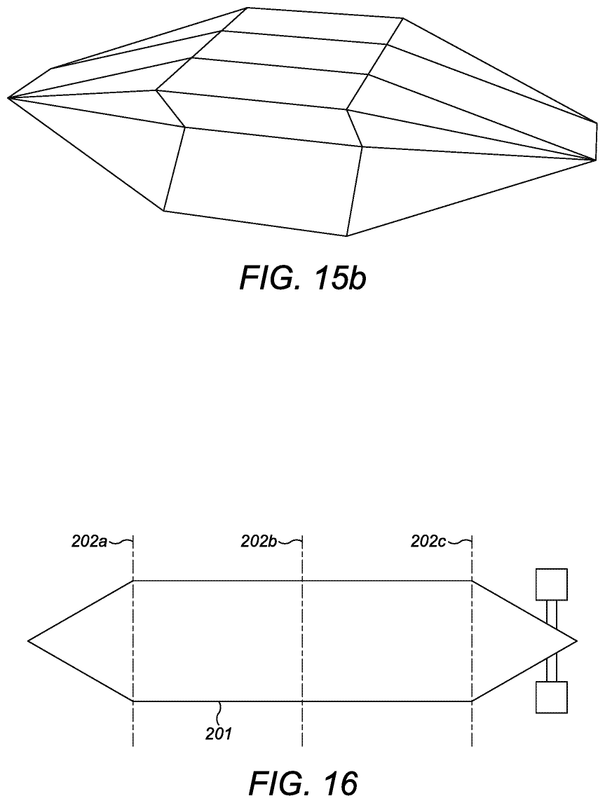

FIGS. 15a and 15b show views of the airship 101 in different configurations. FIG. 15a shows the airship 101 when the volume enclosed by the envelope 104 is at a maximum. As can be seen in FIG. 15a, in this configuration the tapered wedges 106 and 107 have substantially flat side faces and rectangular bases, with their upper and lower edges at their maximum separation. In this configuration the section 108 has a rectangular cross section. This configuration corresponds to the airship 101 having neutral buoyancy at a maximum altitude for its current weight.

FIG. 15b shows the airship 101 when the volume enclosed by the envelope 104 has been reduced, and the pressure of the lifting gas increased by moving the upper and lower edges of the tapered wedges 106 and 107 closer together. As can be seen in FIG. 15b, in this configuration the two tapered wedges 106 and 107 have substantially concave side faces which are folded inwardly, with the upper and lower edges at a separation smaller than their maximum separation. In this configuration the section 108 has a sides which are folded inwardly. This configuration corresponds to the airship 101 having neutral buoyancy at an altitude lower than the maximum altitude of the configuration of FIG. 15a.

A three-segment design according to FIGS. 14, 15a and 15b may have significantly reduced drag compared with the two-segment approach of FIGS. 1 to 13.

The number of pinch points can be varied as desired. FIG. 16 shows a side view of an airship 201 having three pinch points 202a to 202c at spaced apart locations along its length, where the section having a constant cross-section is separated into two segments by the pinch point 202b, but otherwise similar to the airship 101 of FIG. 14. The design of FIG. 16 may be regarded as having four segments.

Increased numbers of segments may allow the airship design to have a shape having a greater length to cross sectional diameter ratio providing a closer approximation to a streamlined body, which may provide reduced drag.

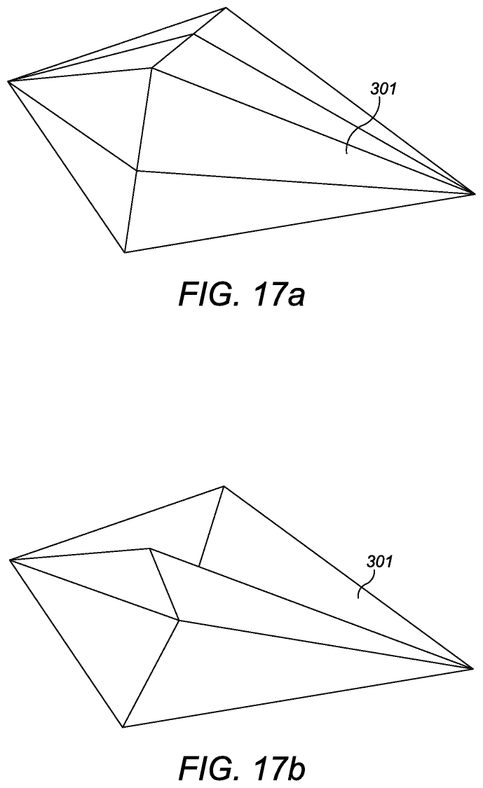

FIGS. 17a and 17b show perspective views of an airship 301 formed by two square based pyramids arranged with their bases in contact. The airship 301 has two pinch points arranged perpendicular to one another to move centers of the sides of the bases of the pyramids inwardly and outwardly to change the volume of an envelope.

Other shapes and arrangements of pinch points can be used. The forward and rearward facing pyramids or wedges can have bases of any shape. The forward and rearward facing wedges or pyramids can have the same height or different heights (the same or different lengths along the longitudinal axis of the airship).

In the illustrated embodiments the frame 3 is formed by substantially rigid struts. In other examples some, or all of the struts may be formed by gas filled inflatable struts.

In the illustrated examples winches and cables are used to drive the frame and control the volume of the envelope 4. In other examples, alternative driving mechanisms may be used.

In the illustrated examples the airship uses helium or hydrogen as the lifting gas. Other examples may use different lifting gasses. In some examples, the lifting gas may be one of, or a mixture comprising more than one of: helium; hydrogen; and methane.

In the illustrated examples the airship 1 uses GPS positioning systems. In other examples, alternative satellite positioning systems may be used instead of, or in addition to, GPS. In some examples alternative types of navigation and/or positioning system may be used instead of, or in addition to, satellite positioning systems.

In the illustrated examples, the airship has four steerable thrusters located at the rear of the airship. In other examples a different number of thrusters may be used, for example three steerable thrusters may be used. In other examples thrusters at other locations may be used. The use of steerable thrusters is not essential. In other examples some, or all, of the thrusters may be fixed. In examples where fixed thrusters are used differential thrust may be used to change the direction of the airship. In some examples, some or all of the thrusters may comprise contra-rotating fans and/or propellers.

In the illustrated examples, ducted fan thrusters are used to provide thrust. In other examples non-ducted thrusters, or a mixture of ducted and non-ducted thrusters may be used.

In the illustrated examples, the airship has no aerodynamic stabilizers or control surfaces. In other examples aerodynamic stabilizers and/or control surfaces may be used.

In the illustrated examples, the airship is powered by PV arrays and a battery array. In other examples the airship may alternatively or additionally have other power sources. In some examples the airship may be powered by a one or more fuel cells.

In the illustrated examples, the airship is equipped for satellite communications. In other examples the airship may alternatively or additionally be equipped for other types of communication, for example to aircraft, or to fixed or mobile surface platforms.

In the illustrated examples, the airship comprises a support member 20. In other examples this may be omitted and various components may be connected directly to the frame.

It will be understood that the benefits and advantages described above may relate to one embodiment or may relate to several embodiments. The embodiments are not limited to those that solve any or all of the stated problems or those that have any or all of the stated benefits and advantages.

Any reference to ‘an’ item refers to one or more of those items. The term ‘comprising’ is used herein to mean including the method steps or elements identified, but that such steps or elements do not comprise an exclusive list and a method or apparatus may contain additional steps or elements.

The order of the steps of the methods described herein is exemplary, but the steps may be carried out in any suitable order, or simultaneously where appropriate. Additionally, steps may be added or substituted in, or individual steps may be deleted from any of the methods without departing from the scope of the subject matter described herein. Aspects of any of the examples described above may be combined with aspects of any of the other examples described to form further examples without losing the effect sought.

It will be understood that the above description of a preferred embodiment is given by way of example only and that various modifications may be made by those skilled in the art. Although various embodiments have been described above with a certain degree of particularity, or with reference to one or more individual embodiments, those skilled in the art could make numerous alterations to the disclosed embodiments without departing from the spirit or scope of this invention.

1. An airship comprising:
an envelope having a shape, a volume, and a frontal area;
a lifting gas within the envelope;
a propulsion system; and
a volume change mechanism arranged to change the shape of the envelope;
wherein the change in shape of the envelope changes the volume of the envelope;
wherein the change in volume of the envelope causes a change in the buoyancy of the airship; and
wherein the change in shape of the envelope causes the frontal area of the envelope to change proportionally to the change in volume of the envelope.

2. The airship of claim 1, wherein the airship has a longitudinal axis and the frontal area of the envelope is the cross-sectional area of the envelope perpendicular to the longitudinal axis.

3. The airship of claim 1, wherein the propulsion system has a thrust axis and the frontal area of the envelope is the cross-sectional area of the envelope perpendicular to the thrust direction.

4. The airship of claim 1, wherein the volume change mechanism is arranged so that a surface area of the envelope remains constant when the shape of the envelope is changed.

5. The airship of claim 1, wherein the change in volume of the envelope causes a change in the pressure of the lifting gas.

6. The airship of claim 1, wherein the shape of the envelope comprises two tapered sections each having a base, the two tapered sections being arranged extending in opposite directions with their respective bases facing one another.

7. The airship of claim 2, wherein the airship further comprises a support member extending along the axis.

8. The airship of claim 1, in which the envelope is transparent, in whole or in part.

9. The airship of claim 1, wherein the airship further comprises at least one solar collector photo-voltaic (PV) panel arranged to provide electrical power to the airship.

10. The airship of claim 1, wherein the airship further comprises at least one battery arranged to store electrical power.

11. The airship of claim 1, wherein the airship further comprises a satellite communication system.

12. The airship of claim 1, wherein the airship further comprises a payload, wherein the payload comprises one of more of: a sensor system; a radar system; a lidar system; a camera; an electro optical system; an infra-red imager; and/or a communications relay.

13. The airship of claim 1, wherein the airship further comprises a frame supporting the envelope.

14. A method of operating an airship, the airship comprising:
an envelope having a shape, a volume, and a frontal area;
a lifting gas within the envelope;
a propulsion system; and
a volume change mechanism;
the method comprising:
operating the volume change mechanism to change a shape and a volume of the envelope;
wherein the change in volume of the envelope causes a change in the buoyancy of the airship; and
wherein the change in the buoyancy of the airship causes the airship to change altitude;
wherein the change in shape of the envelope causes the frontal area of the envelope to change proportionally to the change in volume of the envelope.

15. The method of claim 14, wherein the airship has a longitudinal axis and the frontal area of the envelope is the cross-sectional area of the envelope perpendicular to the longitudinal axis.

16. The method of claim 14, wherein the propulsion system has a thrust axis and the frontal area of the envelope is the cross-sectional area of the envelope perpendicular to the thrust direction.

17. The method of claim 14, wherein a surface area of the envelope remains constant when the shape and volume of the envelope are changed.

18. The method of claim 14, wherein the change in volume of the envelope causes a change in the pressure of the lifting gas.

19. The method of claim 14, and further comprising:
obtaining information regarding wind conditions at different altitudes;
identifying a wind condition at an altitude which is favorable for the airship to travel to a desired location; and
operating the volume change mechanism to change the buoyancy of the airships and cause the airship to change altitude to the altitude of the identified wind condition.

20. The method of claim 19, wherein the airship is station keeping at the desired location; and
wherein the identifying a wind condition comprises identifying an altitude having a wind velocity lower than a maximum airspeed which the propulsion system can provide to the airship.

21. The method of claim 19, wherein the airship operates autonomously.

22. A method of operating a plurality of airships to maintain at least one of the airships at a predetermined location, each airship comprising:
an envelope having a shape, a volume, and a frontal area;
a lifting gas within the envelope;
a propulsion system; and
a volume change mechanism:
the method comprising:
obtaining information regarding wind conditions at different altitudes;
identifying a wind condition at an altitude which is favorable for at least one of the plurality of airships to travel to, or station keep at, the desired location; and
for the at least one of the plurality of airships:
operating the volume change mechanism of the airship to change a shape and a volume of the envelope;
wherein the change in volume of the envelope causes a change in the buoyancy of the airship; and
wherein the change in the buoyancy of the airship causes the airship to change altitude;
wherein the change in shape of the envelope causes the frontal area of the envelope to change proportionally to the change in volume of the envelope; and
operating the propulsion mechanism of the airship to travel towards, or keep station at, the predetermined location.

23. The method of claim 22, wherein, in response to wind conditions at different altitudes being such that it is not possible to maintain a single airship of the plurality of airships at the predetermined location, the method further comprises, for at least a further one of the plurality of airships:
operating the volume change mechanism of the airship to change a shape and a volume of the envelope;
wherein the change in volume of the envelope causes a change in the buoyancy of the airship; and
wherein the change in the buoyancy of the airship causes the airship to change altitude;
wherein the change in shape of the envelope causes the frontal area of the envelope to change proportionally to the change in volume of the envelope; and
operating the propulsion mechanism of the airship to travel towards, or keep station at, the predetermined location;
whereby the at least one of the plurality of airships and the at least a further one of the plurality of airships are successively at the predetermined location.

24. The method of claim 22, wherein the plurality of airships maintain a predetermined formation.

25. The method of claim 22, wherein the plurality of airships each comprise respective sensor systems which cooperate to carry out surveillance of the predetermined location.
